(19) United States
(12) Patent Application Publication
(10) Pub. No.: US 2006/0259505 A1
(43) Pub. Date: Nov. 16, 2006

(54) Diagnostic information input supporting system apparatus, program and method

(75) Inventors: Kazuya Nodate, Yokohama (JP); Tooru Oonishi, Setagaya (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/315,481

(22) Filed: Dec. 21, 2005

(30) Foreign Application Priority Data
May 12, 2005 (JP) 2005-139304

(51) Int. Cl. G06F 7/00

(52) U.S. Cl. 707/102

(57) ABSTRACT

A diagnostic information input supporting apparatus includes a schema information storage for storing a plurality of schema images, a disease name information storage for storing disease name information, and a selection instruction accepting program for accepting a schema image selection instruction for a first schema image from a user. A schema image extracting program extracts the first schema image from the schema information storage based on the schema image selection instruction. A disease name extracting program extracts at least one disease name corresponding to the first schema image from the disease name information storage. The disease name is then displayed with the first schema image.

### FIELD OF INVENTION

The present invention relates to an apparatus, a program, and a method for supporting medical diagnostic information input in a diagnosis supporting system such as an electronic medical sheet, and particularly to a system for enabling selection of the name of a medical condition with which a patient may be afflicted.

### BACKGROUND OF THE INVENTION

In a diagnosis supporting system such as an electronic medical sheet, a doctor, for example, who is a user of the system, medically examines a patient and inputs the determined disease name in the electronic medical sheet. However, since a countless number of diseases exist, it is a very troublesome procedure for a user to determine the target disease name.

A technology for supporting the selection of a disease name by a user through a display of disease names which are used with a high frequency is known. The known technology is effective when the number of high frequency disease names are small. However, when there are a large number of high frequency disease names, it becomes difficult for the user to determine the target disease name.

### SUMMARY OF THE INVENTION

The present invention is directed to a diagnostic information input supporting apparatus including a schema information storage for storing a plurality of schema images, a disease name information storage for storing disease name information, and a selection instruction accepting program for accepting a schema image selection instruction for a first schema image from a user. A schema image extracting program extracts the first schema image from the schema information storage based on the schema image selection instruction. A disease name extracting program extracts at least one disease name corresponding to the first schema image from the disease name information storage. The disease name is then displayed with the first schema image

### BRIEF DESCRIPTION OF THE DRAWINGS

FIG. 1 is a system diagram of a diagnosis supporting system of one embodiment of the present invention;

FIG. 2 is a flowchart describing the overall operation of the diagnosis supporting system of FIG. 1;

FIG. 3 is a diagram illustrating an example of a patient search screen;

FIGS. 4A and 4B are diagrams illustrating an example of a medical sheet editing screen;

FIG. 5 is a flowchart describing a medical sheet editing process;

FIG. 6 is a flowchart describing a schema input process;

FIG. 7 is a diagram illustrating an example of a schema master table;

FIGS. 8A and 8B are diagrams illustrating an example of a schema editing screen showing first and second level schema images, respectively;

FIG. 9 is a flowchart describing a second level schema image display process;

FIG. 10 is a diagram illustrating an example of a disease name master table;

FIG. 11 is a flowchart describing a third level schema image display process;

FIG. 12 is a diagram illustrating an example of the schema image editing screen; and

FIG. 13 is a diagram illustrating an example of the disease history data.

### DETAILED DESCRIPTION OF THE INVENTION

As used in this patent, schema image generally refers to a figure or an outline representing a region or a part of the patient's body. Moreover, the term “disease” is used generally to include medical conditions.

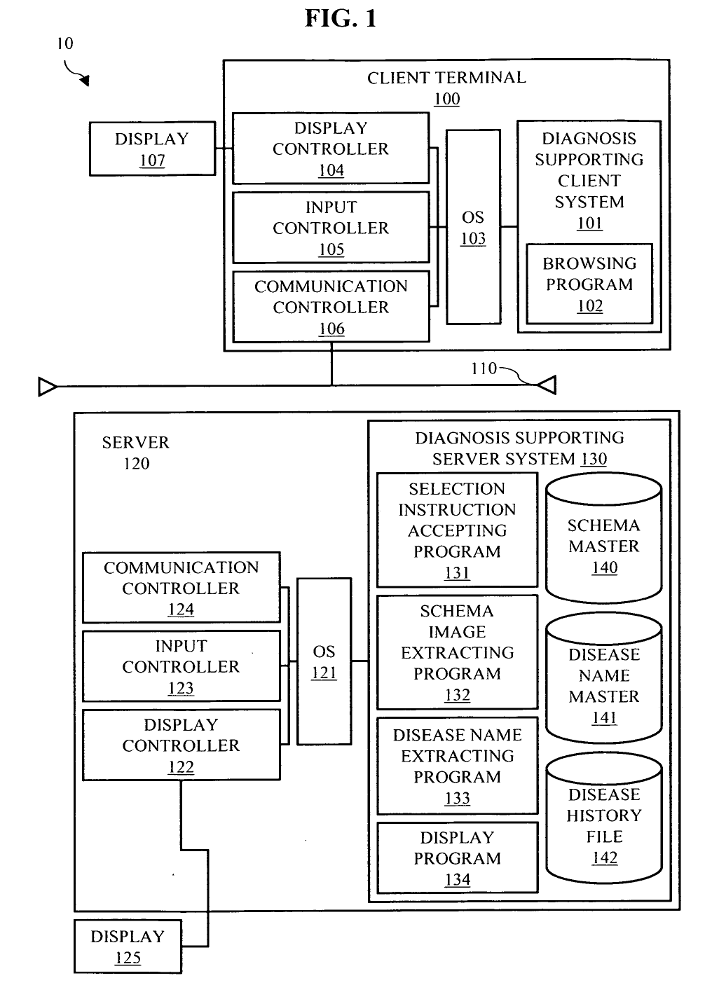

Turning now to FIG. 1, a diagnosis supporting system 10 in accordance with one embodiment of the invention includes a server 120 and a client terminal 100 which are connected to a network 110 such as a LAN or a WAN, for example. In FIG. 1, only one client terminal is illustrated for simplifying the description of the diagnosis supporting system 10. It should be understood, however, that there may be numerous client terminals 100 with similar features.

The server 120 includes an operating system (OS) 121 for operating a diagnosis supporting server system 130. The diagnosis supporting server system 130 supports various programs relating to diagnostic information input by a user. These programs include a selection instruction accepting program 131 for accepting a region selecting instruction of a schema image from a user, a schema image extracting program 132 for extracting the schema image from a schema master 140 that stores schema images, a disease name extracting program 133 for extracting disease name information from a disease name master 141 that stores disease name information, and a display program 134 for displaying a medical sheet editing format to a user. These programs are stored in an external storage device (not illustrated) of the server 120 and retrieved by the diagnosis supporting server system 130 for execution.

The diagnosis supporting server system 130 also includes a disease history file 142 for storing information about the disease history of each patient, which are referred or updated as required from the selection instruction accepting program 131, the schema image extracting program 132, the disease name extracting program 133, and the display program 134.

The server 120 is also provided with a display controller 122 for controlling a display device 125 for displaying various information output by the display controller 122 to a user, an input controller 123 for controlling information input from the user, and a communication controller 124 for controlling communication with the client terminal 100.

The client terminal 100 is connected to the server 120 via the network 10 and includes an operating system (OS) 103 for controlling a diagnosis supporting client system 101. The client terminal 100 may be a personal computer, for example. The diagnosis supporting client system 101 includes a browsing program 102 for inputting information to the diagnosis supporting server system 130 and outputting information from the diagnosis supporting server system.

The client terminal 100 also includes a display controller 104 for controlling a display device 107 for displaying various information output by the display controller 104 to a user, an input controller 105 for controlling information input from the user, and a communication controller 106 for controlling communication with the server 120.

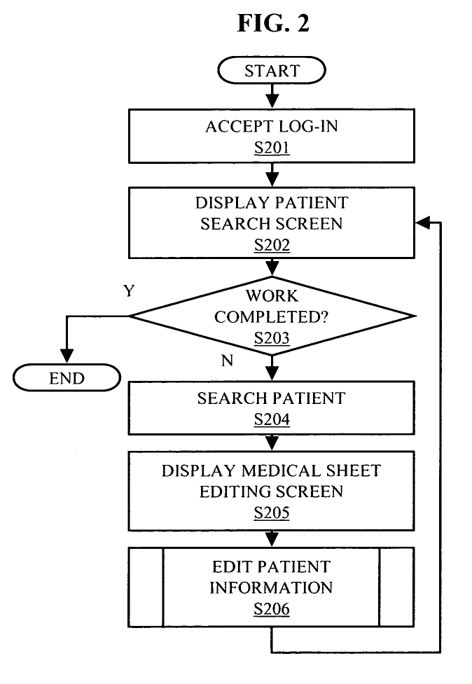

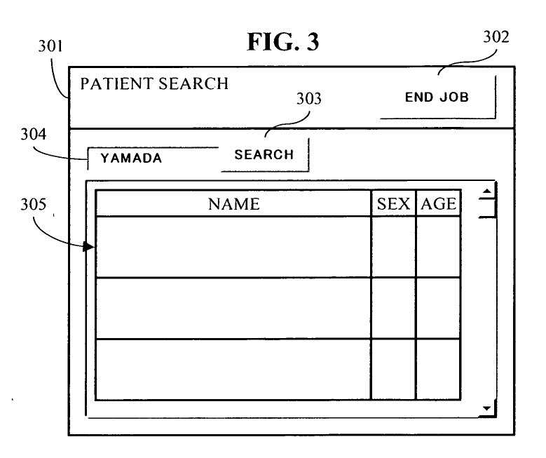

Turning now to FIG. 2 and in operation, a user executes a log-in process on the diagnosis supporting server system 130 from the diagnosis supporting client system 101 of the client terminal 100 (S201). The display program 134 in the diagnosis supporting server system 130 authenticates the user through a known user authentication procedure, and thereafter, controls the client terminal 100 via the communication controller 106 to display a patient search screen (shown in FIG. 3) on the display 107 connected to the client terminal 100 (S202). The patient search screen 301 includes an END WORK button 302, the name of the display image (PATIENT SEARCH), provided with a search button 303 for initiating a search of the patient identified in a patient name area 304, and a list display area 305 for displaying a list of the search result.

To exit the diagnosis supporting system 10, the user selects or activates the END WORK button 302 using known methods, i.e., a computer mouse (not shown), for example. Upon the acceptance of the selection of the END WORK button 304, the diagnosis supporting server system 130 closes the patient search screen 301 (S203). When the user selects the search button 303, the diagnosis supporting server system 130 executes the patient search process for a patient identified by the user in the patient name area 304 (S204), and the display program 134 displays the search result to the list display area 305 of the patient search screen 301.

When the user selects the patient from the list display area 308 of the patient search screen 301, the search may find more than one patient. The display program 134 displays a medical sheet editing screen 401 of the selected patient for inputting and editing patient information including diagnostic treatment information (S205).

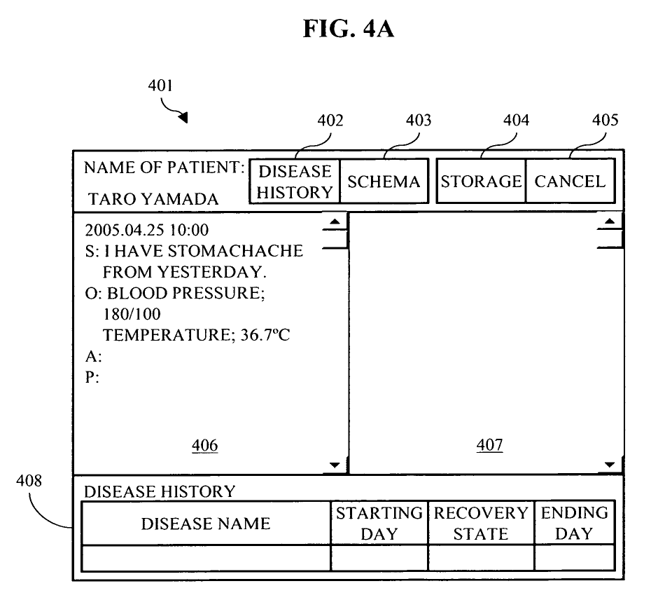

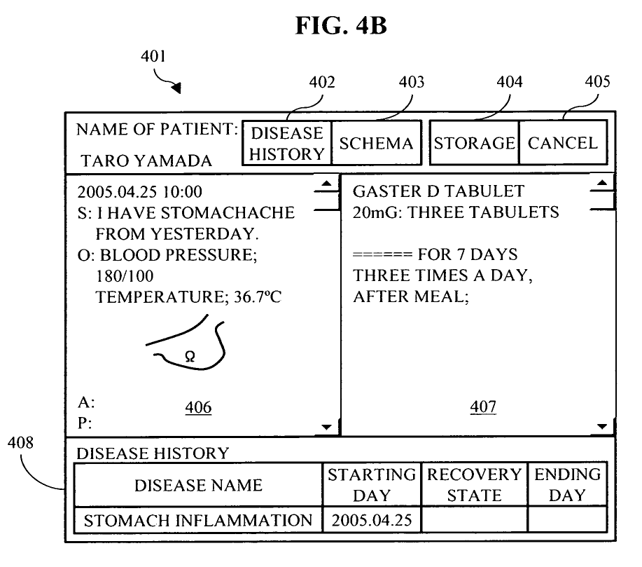

The medical sheet editing screen 401 is shown in FIG. 4, and includes the patient name, a DISEASE HISTORY button 402 which is selected for making reference to the disease history of the patient, a SCHEMA button 403 which is selected for inputting schema, a STORAGE button 404 which is selected for completing the storage of the input diagnostic information, and a cancellation (CANCEL) button 405 which is selected to complete the process without storage of the input diagnostic information. The medical sheet editing screen 401 is also provided with a symptom-progress column 406 for inputting the symptoms and progress of disease, a treatment-prescription column 407 for inputting order information such as treatment and prescription, and a disease history input area 408 for inputting disease history of the patient.

The medical sheet editing screen 401 shown in FIG. 4 and selected by the user, as an example, is for Mr. Taro Yamada. The user has input the diagnostic information of the patient including the data of at least one of Subject (S), Objective (O), Assessment (A), and Plan (P). Referring back to FIG. 2, the user may edit diagnostic information of the patient using this medical sheet editing screen 401 (S206). The user completes editing the diagnostic information of the patient by selecting the STORAGE button 404 or the CANCEL button 405 of the medical sheet editing screen 401. When the user selects the STORAGE button 404, the edited contents are stored. When the user selects the CANCEL button 405, the edited contents are not stored and the process returns to the step S202 to display the patient search screen 301 shown in FIG. 3.

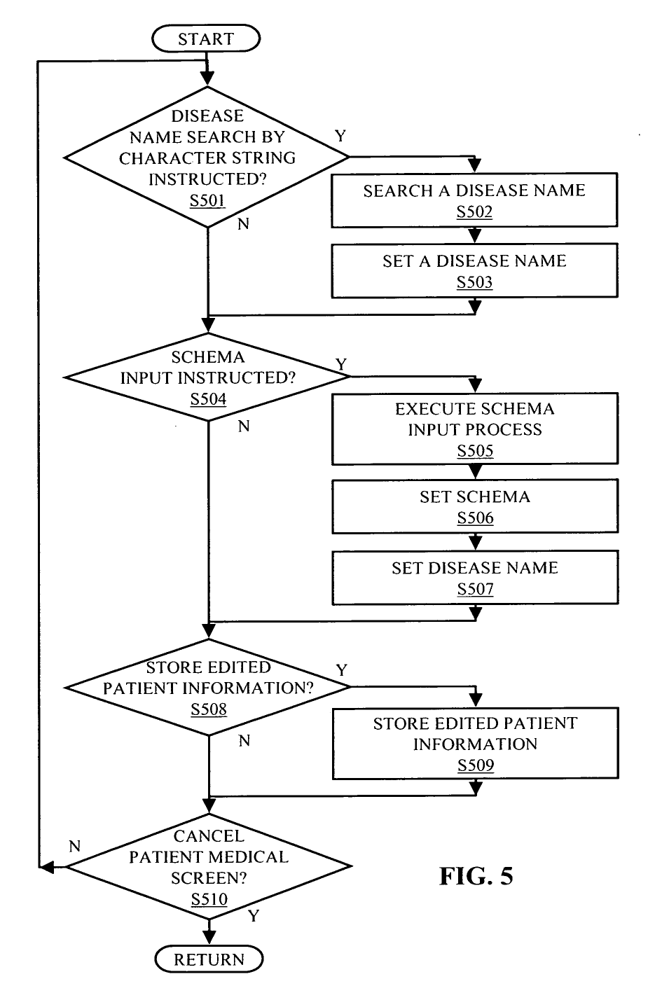

The process for editing patient information (described in the step S206 of FIG. 2) is described with reference to FIG. 5. First, the diagnosis supporting server system 130 determines whether the user has instructed a disease name search using a character string search (S501). If so, the disease name search process is then executed by the disease name extracting program 133 using a known character string search method (S502). The disease name determined from this process is set to the disease history input area 408 of the medical sheet editing screen 401 as shown in FIG. 4B (S503).

If, however, the user issues a schema input instruction by selecting the schema button 402 of the medical sheet editing screen 401 (S504), a schema input process is executed (S505).

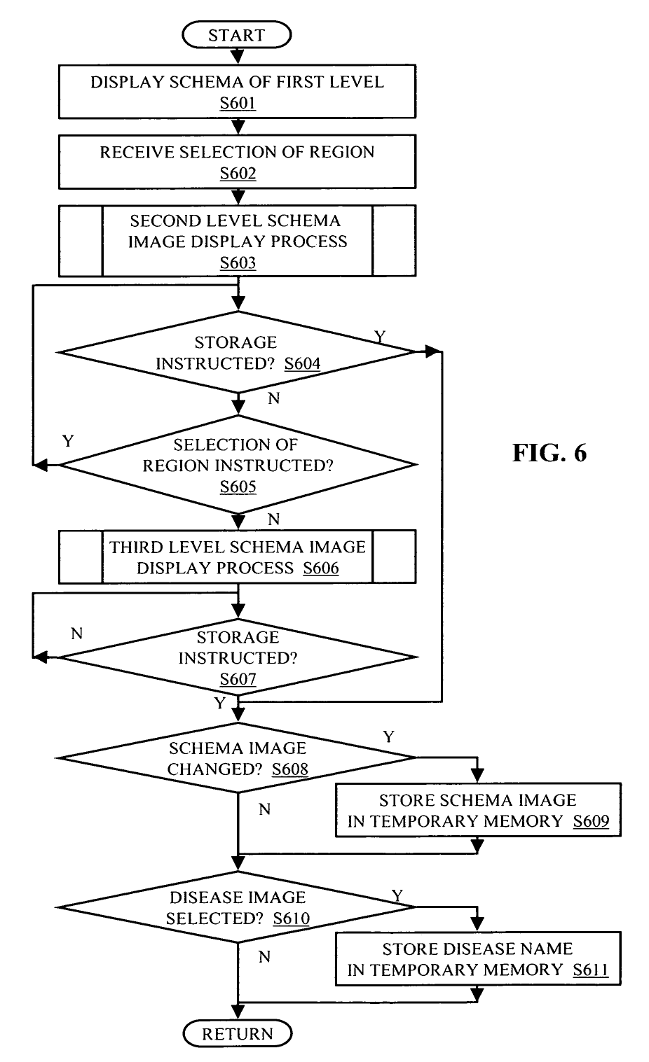

The schema input process (S505) is explained in detail using the flow diagram of FIG. 6. First, the display program 134 (shown in FIG. 1) displays the schema of the first level (S601), which is extracted and displayed from the schema master 140.

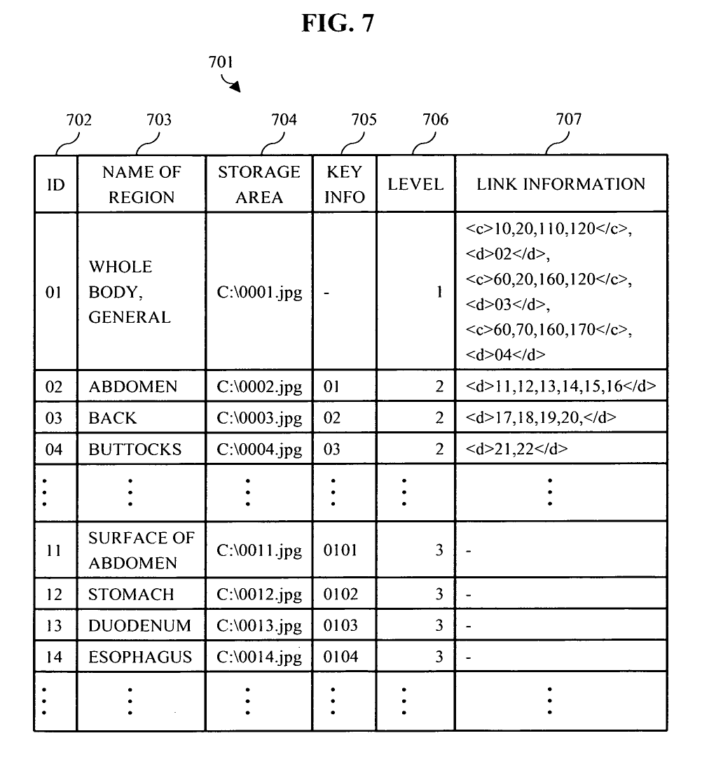

The content of the schema master 140 is represented in a schema master table 701 shown in FIG. 7. The schema master table 701 is used for management of schema images of the patient's body, and includes the columns for ID 702, names of the region of the body 703, storage areas of the schema image 704, key information 705, levels 706, and link information 707. Here, the level indicates the degree of detail of the patient's body represented by the schema images. The highest hierarchical level is defined as level 1 (which is indicated with a record of ID=01) referring to the whole body of the patient. The next highest hierarchical level is defined as level 2, referring to the abdomen, the back, the buttocks, for example. The lowest hierarchical level is defined as level 3 indicating the most detailed region such as the surface of abdomen, stomach, duodenum, esophagus or the like. The key information 705 and the link information 707 are described below.

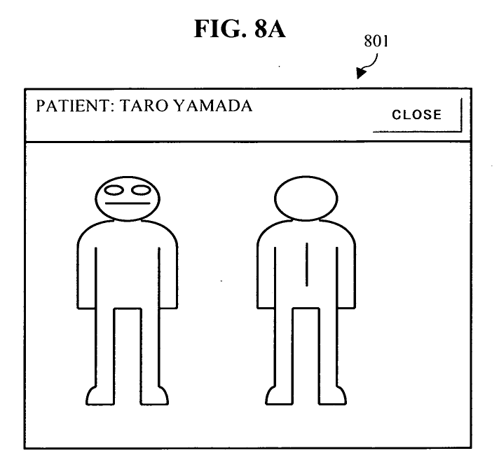

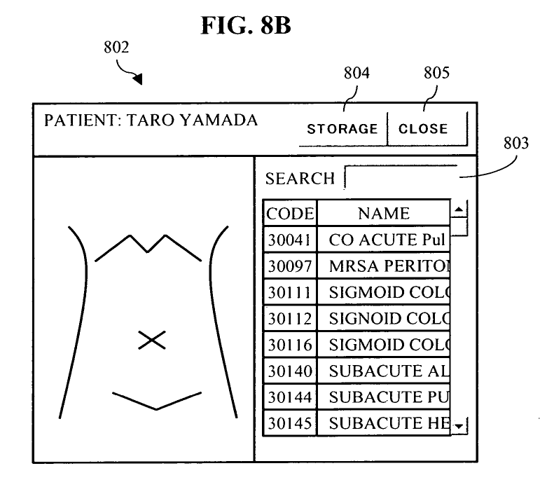

In the process for displaying the schema image of the first level (S601), the storage area of the schema image is acquired by referring to the record of level 1 in the schema master table 701 (shown in FIG. 7). The schema image is displayed on the schema editing screen 801 of the display 7 as shown in FIG. 8A. The schema editing screen 801 displays the schema image corresponding to level 1, which is the whole body of the patient. A plurality of link information pieces are embedded within the parts of the schema image on the schema editing screen 801. Link information is stored in the link information column 707 of the schema master table 701. The information provided between <c> and </c> indicates the coordinates and the information provided between <d> and </d> indicates the ID of the schema image to be displayed next. For example, a link to the abdomen for which the ID in the schema master table 701 is 02 is embedded within the rectangular area indicated by the left upper (X, Y) coordinates 10, 20 and the right lower (X, Y) coordinates 110, 120 on the image of displayed on the schema image editing screen 801. In the same manner, a link to the back of the patient for which the ID in the schema master table 701 is 03, might be embedded in the left upper coordinates 60, 20 and the right lower coordinates 160, 120. A user selects, e.g., “clicks” the desired area on the schema editing screen 801 to which the link information pieces is embedded. The selection instruction accepting program 131 (shown in FIG. 1) receives the selection by the user (S602), and initiates a second level schema display process (S603).

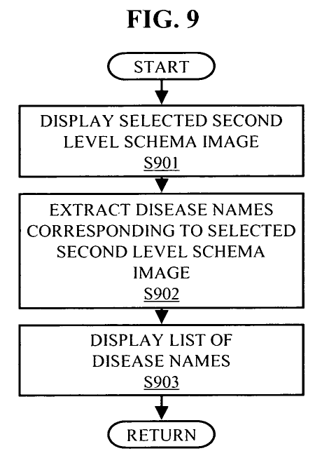

Referring to FIG. 9, in the second level schema image display process the schema image extracting program 132 extracts the schema image based on the link information piece selected by the user in step S602, and the display program 134 displays the extracted schema image on the display 107 (S901). For example, when the user clicks the abdomen area of the whole body image, i.e., the level 1 schema image (shown in FIG. 8A), the schema image extracting program 132 detects that the schema master ID of the schema image (i.e., the abdomen area of the patient) to be displayed next is 02 by the link information embedded in the body area clicked by the user. Thereafter, the corresponding schema image is extracted from the storage area (c:\0002.jpg) indicated in the schema master table, and the display program 134 displays the image on a schema image editing screen 802 (S901) as shown in FIG. 8B.

Next, the disease name extracting program 133 extracts the disease names (S902) associated with the second level schema image shown in the schema image editing screen 802 based on the key information corresponding to the abdomen, which in this example is 01. The disease name extracting program 133 then extracts all the disease names related to the abdomen from the disease name master 141 using this key information.

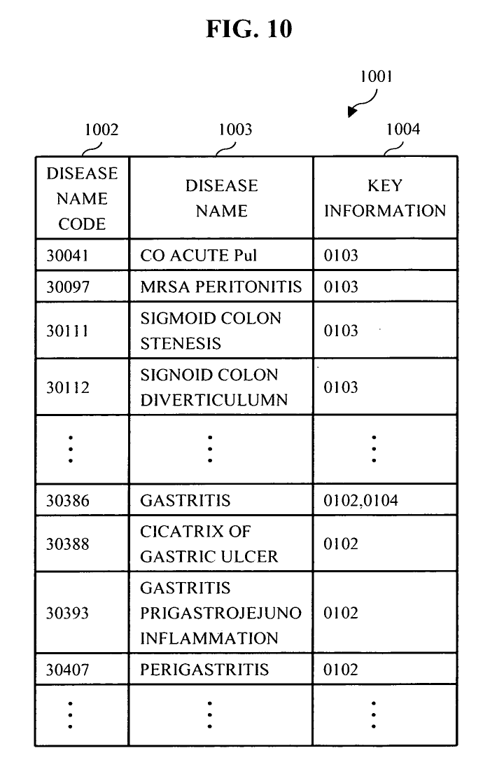

The disease name master 141 is illustrated in a disease name master table 1001 FIG. 10, and includes a disease name code column 1002, a disease name column 1003, and a key information column 1004. Since the key information related to the schema diagram of the abdomen is 01, all records having the key information in which the first and second digits of four digits are 01 is extracted from the records of the disease name master 141. As shown in the disease name master table 1001, the records having the key information of 0102, 0103, 0104 corresponds to the abdomen.

The display program 134 displays the list of disease names extracted on the same schema image editing screen 802 as the corresponding schema image (S902). On the schema image editing screen 802, the user is allowed to write data on the schema image such as comments or marks, for example, or select a disease name in this display screen.

Since only the disease names related to the abdomen are listed on the schema image editing screen, the user is able to select the name of a disease from a relatively small number of disease names. To select a disease name, a search character string of a disease name may be entered in a character input area 803 or directly select any of the displayed disease names.

Thereafter, when the user selects a storage button 804 provided on the schema image editing screen 802, the process goes to the step S608 which is described below (S904). When the user selects a “close” button 805 provided on the schema image editing screen 802, instructions input by the user are cancelled and the schema image editing screen is closed.

When the user desires to display a more detailed schema image on the schema image editing screen 802, the user clicks anywhere on the schema image (i.e., the abdomen) currently shown on the schema image editing screen 802. When the selection instruction accepting program 131 receives this instruction (S605), a third level schema display process is started (S606).

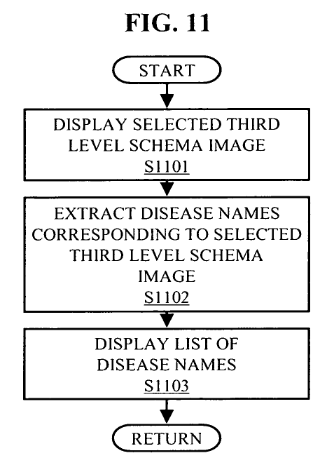

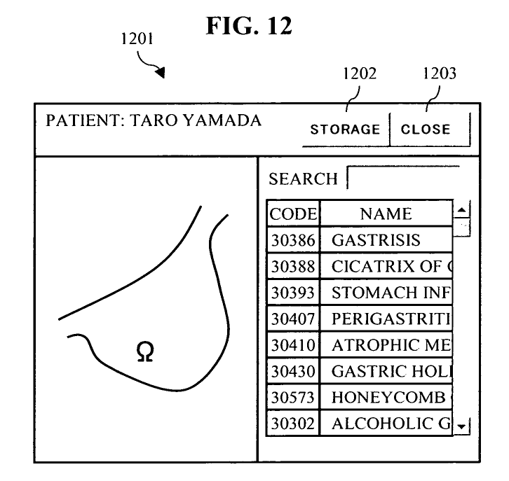

The third level schema image display process is described with reference to the flowchart of FIG. 11. First, the schema image extracting program 132 extracts the schema image selected by the user, and display program 134 displays the extracted schema image on the display 107 (S1101). More specifically, when the user selects or clicks on a region of the second level schema image shown on the schema editing screen 802, the LINK INFORMATION of the record associated with that region is obtained from the schema master table 701. The LINK INFORMATION provides the ID indicating a candidate of the schema image to be displayed next. The schema master table 701 indicates that records 11, 12, 13, 14, 15, and 16 correspond to such ID. Here, the display program 134 displays a screen on the display 107 showing a list of names in the NAMES of REGION 703 corresponding to these schema master IDs such as surface of abdomen, stomach, duodenum, and esophagus, as in the example shown in FIG. 7. When the user selects or “clicks” on one of these names, e.g., the stomach, the selected schema image is displayed on the display 107 as a schema image editing screen 1201 shown in FIG. 12.

Next, the disease name extracting program 133 extracts all the disease names (S1102) corresponding to the selected schema image. For example, when the user has selected the schema of a stomach on the abdomen (shown in FIG. 8B), it is detected that the schema master ID of the schema to be displayed next is 12 (as shown in FIG. 7). Thereafter, the KEY INFORMATION of the relevant record is detected as 0102, and the disease name extracting program 133 extracts the disease names related to the stomach from the disease name master 141 using this KEY INFORMATION. Since the KEY INFORMATION related to the schema of stomach is 0102, the record having the KEY INFORMATION in which the first to fourth digits of the four digits are 0102 is extracted from the records of the disease name master 141 as shown in the disease name master table 1001. The display program 134 displays a list of the disease names extracted in step S1102 on the schema image editing screen 1201 next to the third level schema image (S1103).

From the schema image editing screen 1201, the user is allowed to write data the schema image, or select the disease name in this display screen. In the example of the medical sheet editing screen 1201, a polyp has been added to the image of the stomach using a computer drawing tool.

Since the disease names related only to stomach are displayed, the user is able to easily select a from a relatively small list of disease names relating to the patient's stomach and not from a larger list of disease names which may not be specifically related to the stomach. Once the desired disease name is determined the user can type in the character string of the disease name using the character input area 1201, or select or click directly on the disease name shown on the list 1201.

Thereafter, when the user selects a storage button 1202, the process goes to the step S608 shown in FIG. 6. When the user selects a “close” button 1203 provided on the schema image editing screen 1201, instructions input by the user are all cancelled and the image displayed on the schema image editing screen 1201 is closed.

Referring back to FIG. 6, it is judged whether data has been written to the schema image by the user before the selection of the storage button (S608) (e.g., an addition of a polyp as in FIG. 12). When data has been written, the edited schema image is stored to a temporary memory (not shown) in the server 120 (S609). Next, it is determined as to whether a disease name has been selected by the user before the selection of the storage button (S610). When the disease name has been selected, it is stored to the temporary memory (S611).

Thereafter, the schema image stored in the temporary memory is displayed on a medical sheet editing screen 401 (S506), as illustrated, as an example, in FIG. 4B. The disease name stored in the temporary memory in step S611 is also displayed on the medical sheet editing screen 401 (S507). Accordingly, a disease name is displayed in the disease history input area 408 of the medical sheet editing screen 401. A user may input in the treatment-prescription column 407 the medical sheet editing screen 401, prescription order information, or comments, for example. As discussed above, one advantage of the system of the present invention, is that the data can be written on the schema image simultaneously with or in the same process for the selection of a disease name.

When the STORAGE button 404 is selected in the medical sheet editing screen 401 (S508), the edited patient information in the treatment-prescription column 407 is stored in a server file (not shown) (S509). The medical sheet information input in the symptom-progress column 406 is also stored. In this case, the schema image stored in the temporary memory in step 609 is stored in a server file (not shown) in relation to the relevant medical sheet information.

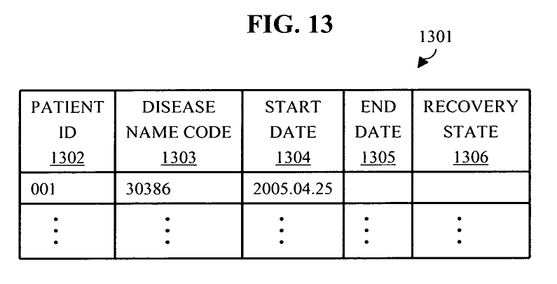

Thereafter, the information input to the disease history input area 408 of the medical sheet editing screen 401 is stored in the disease history data storage 142. An example of the disease history data is illustrated in the disease history data table 1301 of FIG. 13. The disease history data table 1301 includes columns for a PATIENT ID 1302, a DISEASE NAME CODE 1303, a START DATE 1304, an END DATE 1305, and a RECOVERY STATE 1306. In the process of step S511, the DISEASE NAME CODE corresponding to the disease name input to the disease history input area 408 of the medical sheet editing screen 401 is written together with the PATIENT ID. Moreover, the start date input by the user to the same image is also stored. If the patient recovers later, the date of recovery is written into the END DATE column 1305 and “complete recovery” is stored into the RECOVERY STATE column 1306. The medical sheet editing process (S206) is then completed.

When the CANCEL button 405 is selected in the medical sheet editing screen 401 (S510), the edited patient information, the medical sheet information, the schema image and the information inputted to the disease history input area are not stored, and the medical sheet editing process (S206) is completed.

When the medical sheet editing process (S206) has been completed as explained above, the patient search screen 301 is displayed again (S202) (shown in FIG. 2).

The present invention enables selection of the target disease name by utilizing schema images. Since only the disease names related to the schema image is displayed, it is possible for a user to select the desired disease name from the list that is specifically related to the schema image showing a particular region of the patient body.

In the above-described embodiment of the present invention, patient data is stored by the diagnosis supporting server system 130 of the server 120. However, the same data may be stored in the diagnosis supporting client system 101 of the client terminal 100. Moreover, the diagnosis supporting system 10 may be implemented entirely in a single unit of the personal computer rather than being connected to the server 120. In this case, the program, and the function of the diagnosis supporting server system 130 are supported in the diagnosis supporting client system 101 of the personal computer.

Moreover, the programs that enable the functions of the client terminal 100 and the server 120 described above may be stored on a recording medium such as a CD-ROM, for example, and installed in the client terminal 100, or the client terminal 100 and the server 120.

In addition, the diagnosis supporting server system 130 is not always required to be implemented in a medical institution. For example, it is also possible that such system function as a server in an application service provider (ASP) and the services provided in accordance with access from the diagnosis supporting client system 100 in each medical institution. In this case, the present invention can be realized when the server of the ASP provider execute the diagnostic information input supporting function of the present invention.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. A diagnostic information input supporting apparatus comprising:
schema information storing means for storing a plurality of schema images;
disease name information storing means for storing disease name information;
selection instruction accepting means for accepting a schema image selection instruction for a first schema image from a user;
schema image extracting means for extracting said first schema image from said schema information storing means based on said schema image selection instruction;
disease name extracting means for extracting at least one disease name corresponding to said first schema image from said disease name information storing means; and
display means for displaying said first schema image and said at least one corresponding disease name.

2. The diagnostic information input supporting apparatus as defined in claim 1, wherein said schema image selection instruction includes selecting a second schema image displayed on said display means.

3. The diagnostic information input supporting apparatus as defined in claim 2, wherein said schema information storing means stores said plurality of schema images in a plurality of levels; and
said first schema image is in a first level and said second schema image is in a second level.

4. The diagnostic information input supporting apparatus as defined in claim 3, wherein said first schema image is a region of said second schema image.

5. The diagnostic information input supporting apparatus as defined in claim 4, wherein said at least one disease name corresponding to said first schema image is a subset of at least one disease name corresponding to said second schema image.

6. The diagnostic information input supporting apparatus as defined in claim 1, wherein said first schema image includes a figure indicating a region of a body of a patient.

7. A computer program stored on a computer readable medium or a propagated signal, the computer program having instructions for controlling a computer to perform the steps comprising:
Accepting a schema image selection instruction for a first select schema image from a user;
extracting said first schema image from a schema information storing means for storing a plurality of schema images, based on said schema image selection instruction;
extracting at least one disease name corresponding to said first schema image from a disease name information storing means for storing disease name information; and
displaying said first schema image and said at least one corresponding disease name.

8. The computer program as defined in claim 7, wherein said schema image selection instruction includes selecting a second schema image displayed on said display means.

9. The computer program as defined in claim 8, wherein said schema information storing means stores said plurality of schema images in a plurality of levels; and
said first schema image is in a first level and said second schema image is in a second level.

10. The computer program as defined in claim 9, wherein said first schema image is a region of said second schema image.

11. The computer program as defined in claim 10, wherein said at least one disease name corresponding to said first schema image is a subset of at least one disease name corresponding to said second schema image.

12. The computer program as defined in claim 7, wherein said first schema image includes a figure indicating a region of a body of a patient.

13. A diagnostic information providing method comprising:
accepting a schema image selection instruction for a first select schema image from a user;
extracting said first schema image from a schema information storing means for storing a plurality of schema images, based on said schema image selection instruction;
extracting at least one disease name corresponding to said first schema image from a disease name information storing means for storing disease name information; and
displaying said first schema image and said at least one corresponding disease name to said user.

14. The diagnostic information providing method as defined in claim 13, wherein said schema image selection instruction includes selecting a second schema image by said user.

15. The diagnostic information providing method as defined in claim 14, wherein said schema information storing means stores said plurality of schema images in a plurality of levels; and
said first schema image is in a first level and said second schema image is in a second level.

16. The diagnostic information providing method as defined in claim 15, wherein said first schema image is a region of said second schema image.

17. The diagnostic information providing method as defined in claim 16, wherein said at least one disease name corresponding to said first schema image is a subset of at least one disease name corresponding to said second schema image.

18. The diagnostic information providing method as defined in claim 13, wherein said first schema image includes a figure indicating a region of a body of a patient.
